(19) United States
(12) Patent Application Publication
(10) Pub. No.: US 2004/0044735 A1
(43) Pub. Date: Mar. 4, 2004

(54) Method and system for organizing an email thread

(75) Inventor: Robert S. Hoblit, Knightdale, NC (US)

Correspondence Address: IBM Corporation, Personal and Printing Systems Group Legal Dept., Dept. 9CCA/Bldg. 002-2, P.O. Box 12195, Research Triangle, NC, 27709, US

(73) Assignee: International Business Machines Corporation, Armonk, NY

(21) Appl. No.: 10/232,143

(22) Filed: Aug. 30, 2002

(51) Int. Cl. G06F 15/16

(52) U.S. Cl. 709/206

(57) ABSTRACT

A method and system for organizing an email thread, the email thread comprising a plurality of email messages, is disclosed. The method and system comprise minimizing redundancy within the plurality of email messages to provide a minimized email thread and displaying the minimized email thread. Through the use of the method and system in accordance with the present invention, email threads are organized and listed in a more comprehensive fashion. Furthermore, the amount of redundancy that occurs within an email thread is substantially reduced thereby minimizing the amount of computer memory/disk space hat is consumed by the email system.

### FIELD OF THE INVENTION

The present invention relates generally to a system for managing electronic messages, and particularly, to a method and system for organizing an email thread.

### BACKGROUND OF THE INVENTION

Electronic mail, or e-mail, provides a convenient and easy means for two or more individuals to communicate electronically. E-mail systems today help users send text-based and binary messages through extensive communication networks so that two or more users, who may be in remote locations, can communicate. E-mail may also be used for delivery of important business, financial, sports and other types of information from centralized repositories. The use of e-mail today has become so pervasive that many users now need a way to manage the influx of messages sent to their electronic mailboxes.

This is particularly true in the case of the e-mail thread. An e-mail thread is an email “conversation” that takes place amongst a group of people about a topic of interest. For example, a user of an email system will sometimes send an email to multiple recipients. Typically, the email message encourages or requests responses from the multiple recipients. In most cases, each recipient that responds to the original email message will include the original email message as a reference so that the recipients of the reply message do not need to “find” the original message. For instance, in its simplest case, a single email to a group of 6 people can result in seven documents in a single email inbox, each with the same original email attached, making it difficult to review all of the input at one time.

However, in a more complex case, if each of the six individuals replied to each of the other six individuals email reply, each recipient would have created one original reply, plus five responses to other recipients' comments, or six emails. In this case, a single email can result in 37 (1 original plus 6 first round replies from each recipient plus 30 (5 replies times 6 individual)) different document, 36 of which have unique material contained within them. The six first round emails each contain two parts, the original message and the reply. Accordingly, ½ of each first round email (the original message) is redundant in the originator's inbox. The second round of email messages each contain three parts (the original message, a reply, and new content) ⅔ of which (the original message and the reply) are redundant. Consequently, as more groups are added to the thread, the amount of redundancy across all of the users rises in an exponential fashion. This redundancy takes up a substantial amount of computer memory/disk space and in today's computer market memory/disk space is at a premium.

Accordingly, what is needed is an alternative method for organizing email threads. The method should be somewhat simple, cost effective and capable of being easily adapted into existing technology. The present invention addresses such a need.

### SUMMARY OF THE INVENTION

A method and system for organizing an email thread, the email thread comprising a plurality of email messages, is disclosed. The method and system comprise minimizing redundancy within the plurality of email messages to provide a minimized email thread and displaying the minimized email thread.

Through the use of the method and system in accordance with the present invention, email threads are organized and listed in a more comprehensive fashion. Furthermore, the amount of redundancy that occurs within an email thread is substantially reduced thereby minimizing the amount of computer memory/disk space that is consumed by the email system.

### BRIEF DESCRIPTION OF THE DRAWINGS

FIG. 1 illustrates a typical client-server environment in which an exemplary embodiment of the present invention operates.

FIG. 2 is an exemplary system for implementing the invention that includes a conventional personal computer which serves as a client.

FIG. 3 is a high-level flow chart of the method of organizing an email thread in accordance with the present invention.

FIG. 4 is a more detailed flowchart of step 310 of FIG. 3.

FIGS. 5(A-D) represent diagrammed illustrations of the method in accordance with the present invention.

### DETAILED DESCRIPTION

The present invention relates to a method and system for organizing an email thread While the invention will be described in the general context of an application program that runs on an operating system in conjunction with a personal computer and in connection with a server, those skilled in the art will recognize that the invention also may be implemented in combination with other program modules. Generally, program modules include routines, operating systems, application programs, components, data structures, etc. that perform particular tasks or implement particular abstract data types. Moreover, those skilled in the art will appreciate that the invention may be practiced with other computer system configurations, including hand-held devices, multiprocessor systems, microprocessor-based or programmable consumer electronics, minicomputers, mainframe computers, and the like.

The present invention is presented in the context of a preferred embodiment. The preferred embodiment of the present invention is a method and system for organizing an email thread. Through the use of the method and system in accordance with the present invention, email threads are organized and listed in a more comprehensive fashion. Furthermore, the amount of redundancy that occurs within an email thread is substantially reduced thereby minimizing the amount of computer memory/disk space that is consumed by the email system.

The invention may also be practiced in distributed computing environments where tasks are performed by remote processing devices that are linked through a communications network. In a distributed computing environment, program modules may be located in both local and remote memory storage devices. Execution of the program modules may occur locally in a stand-alone manner or remotely in a client/server manner. Examples of such distributed computing environments include local area networks of an office, enterprise-wide computer networks, and the Internet.

The Internet, which is a global web of interconnected computers and computer networks, integrates local area networks (LANs) located in various entities, such as businesses, libraries, federal agencies, institutes of learning, and research organizations into a single communication network. The Internet uses a common communication protocol suite, known as a Transmission Control Protocol/Internet Protocol (TCP/IP), which was specifically designed for the interconnection of different computer systems. Internal and external networks are linked by routers that route data packets from a sending network to another router or a receiving network. Gateways handle data transfer and conversion of messages from a sending network to the protocols used by a receiving network. Typically, gateways refer to devices that translate between applications. For example, e-mail gateways translate messages from one vendor's messaging program to another vendor's messaging program so that users with different e-mail programs can share messages over a network.

The Internet uses a message standard, known as a Simple Mail Transfer Protocol (SMTP), which works in conjunction with a user's e-mail program and defines the control messages used by two computers to exchange e-mail messages. Such controls include verification of proper connection, identification of sender, negotiation of transmission parameters, and message transmission. SMTP is responsible for 1) sending mail created by a local user to another computer and 2) receiving mail from other computers on the network and transferring it to the local user's e-mail program.

Typically, the computers connected to a wide area network such as the Internet are identified as either servers or clients. A server is a computer that stores files that are available to the other computers connected to the network. For example, an e-mail server manages message traffic and mail boxes for users, in addition to translation facilities or gateways that allow message exchange between different types of e-mail programs. A client is a computer connected to the network that accesses shared resources provided by a server. To obtain information from a server, a client makes a request for a file or information located on the server using a specified protocol. Upon reception of a properly formatted request, the server downloads the file or information to a local message store located at the client.

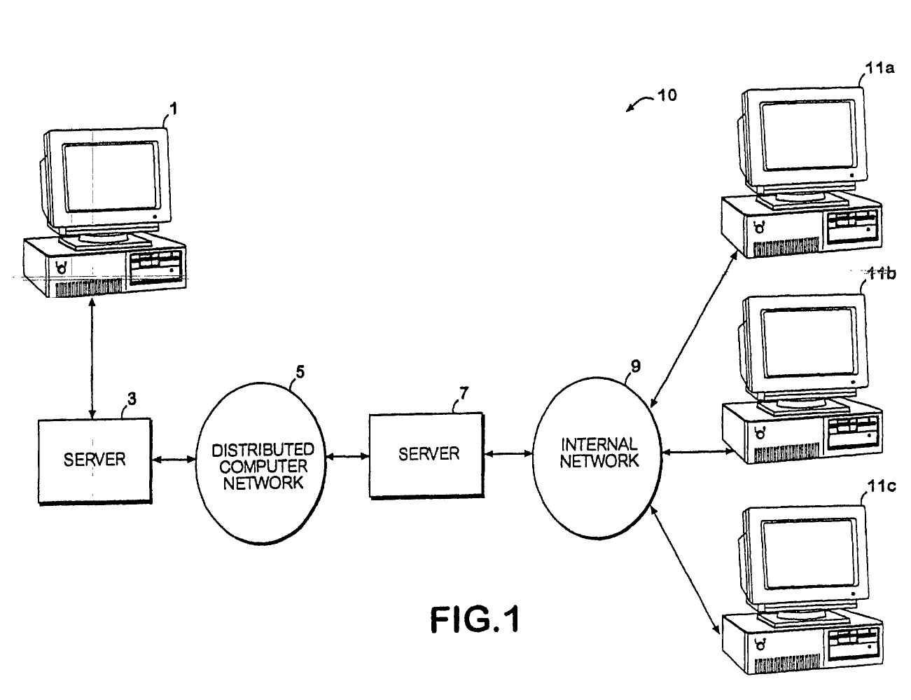

FIG. 1 illustrates a typical client-server environment 10 in which an exemplary embodiment of the present invention operates. A computer system or client 1, such as a conventional personal computer or any device operable to communicate over a network, is connected to an Internet server computer 3 (“server”). The server 3 is generally provided by an Internet service provider (ISP), which provides Internet access for a typical Internet user. The server 3 is connected to a distributed computer network 5, such as the Internet, and enables the client 1 to communicate via the distributed computer network 5.

The client 1 communicates via the combination of the server 3 and the distributed computer network 5 to a server 7, such as a communication or an e-mail server. In an exemplary embodiment, servers 3 and 7 support e-mail services, contain a message store for holding messages until delivery, and contain a translation facility or gateway for allowing users having different e-mail programs to exchange mail. The server 7 is connected to an internal network 9 and enables the client 1 to communicate with the clients 11a, 11b, and 11c via the internal network 9.

The clients 11a, 11b, and 11c are not only able to respond to a communication from the client 1, but are also able to initiate communication with the client 1. The clients 11a, 11b, and 11c can send information via the internal network 9 to the server 7. The server 7, in turn, forwards the information to the client 1 via the distributed computer network 5. The information is retrieved by the server 3 and can be forwarded to the client 1, when requested by the client 1.

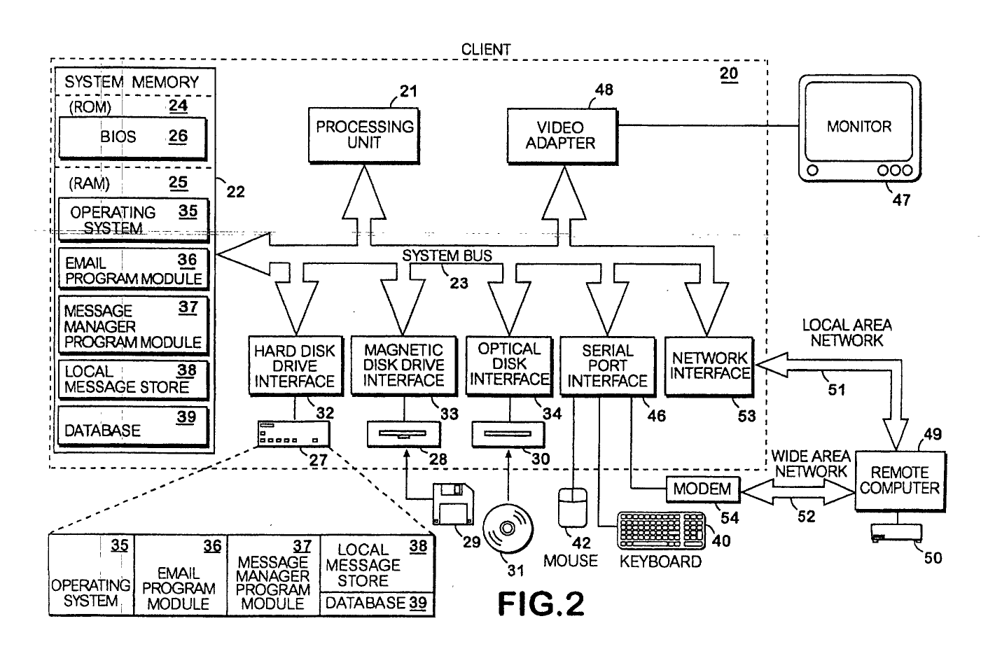

With reference to FIG. 2, an exemplary system for implementing the invention includes a conventional personal computer 20, which serves as a client. The client 20 may represent any or all of the clients 1, 11a, 11b, and 11c illustrated in FIG. 1. The client 20 includes a processing unit 21, a system memory 22, and a system bus 23 that couples the system memory to the processing unit 21. The system memory 22 includes read only memory (ROM) 24 and random access memory (RAM) 25. A basic input/output system 26 (BIOS), containing the basic routines that help to transfer information between elements within the client 20, such as during START-up, is stored in ROM 24. The client 20 further includes a hard disk drive 27, a magnetic disk drive 28, e.g., to read from or write to a removable disk 29, and an optical disk drive 30, e.g., for reading a CD-ROM disk 31 or to read from or write to other optical media. The hard disk drive 27, magnetic disk drive 28, and optical disk drive 30 are connected to the system bus 23 by a hard disk drive interface 32, a magnetic disk drive interface 33, and an optical drive interface 34, respectively. The drives and their associated computer-readable media provide nonvolatile storage for the client 20.

Although the description of computer-readable media above refers to a hard disk, a removable magnetic disk and a CD-ROM disk, it should be appreciated by those skilled in the art that other types of media which are readable by a computer, such as magnetic cassettes, flash memory cards, digital video disks, Bernoulli cartridges, and the like, may also be used in the exemplary operating environment.

A number of program modules may be stored in the drives and RAM 25, including an operating system 35, one or more application programs, such as an e-mail program module 36, other program modules, such as a message manager program module 37, a local message store 38, and a database 39 for supporting e-mail applications. A user may enter commands and information into the client 20 through a keyboard 40 and pointing device, such as a mouse 42. Other input devices (not shown) may include a pen, touch-operated device, microphone, joystick, game pad, satellite dish, scanner, or the like. These and other input devices are often connected to the processing unit 21 through a serial port interface 46 that is coupled to the system bus, but may be connected by other interfaces, such as a game port or a universal serial bus (USB). A monitor 47 or other type of display device is also connected to the system bus 23 via an interface, such as a video adapter 48. In addition to the monitor, personal computers typically include other peripheral output devices (not shown), such as speakers or printers.

The client 20 operates typically in a networked environment using logical connections to one or more remote computers, such as a remote computer 49. The remote computer 49 may be an e-mail server (which includes one or more message stores), as described above in connection with FIG. 1, a file server (which includes one or more file stores), a router, a peer device or other common network node, and typically includes many or all of the elements described relative to the client 20, although only a memory storage device 50 has been illustrated in FIG. 2. The logical connections depicted in FIG. 2 include a local area network (LAN) 51 and a wide area network (WAN) 52. Such networking environments are commonplace in offices, enterprise-wide computer networks, intranets and the Internet.

When used in a LAN networking environment, the client 20 is connected to the LAN 51 through a network interface 53. When used in a WAN networking environment, the client 20 typically includes a modem 54 or other means for establishing communications over the WAN 52, such as the Internet. The modem 54, which may be internal or external, is connected to the system bus 23 via the serial port interface 46. In a networked environment, program modules depicted relative to the client 20, or portions thereof, may be stored in the remote memory storage device. It will be appreciated that the network connections shown are exemplary and other means of establishing a communications link between the computers may be used.

A method in accordance with the present invention may be implemented, for example, by operating a computer system to execute a sequence of machine-readable instructions. The instructions may reside in various types of computer readable media. In this respect, another aspect of the present invention concerns a programmed product, comprising computer readable media tangibly embodying a program of machine readable instructions executable by a digital data processor to perform a method for organizing an email thread.

This computer readable media may comprise, for example, RAM (not shown) contained within the system. Alternatively, the instructions may be contained in another computer readable media such as a magnetic data storage diskette and directly or indirectly accessed by the computer system. Whether contained in the computer system or elsewhere, the instructions may be stored on a variety of machine readable storage media, such as a DASD storage (e.g. a conventional “hard drive” or a RAID array), magnetic tape, electronic read-only memory, an optical storage device (e.g., CD ROM, WORM, DVD, digital optical tape), paper “punch” cards, or other suitable computer readable media including transmission media such as digital, analog, and wireless communication links. In an illustrative embodiment of the invention, the machine-readable instructions may comprise lines of compiled C, C++, or similar language code commonly used by those skilled in the programming for this type of application arts.

As previously articulated, an email thread involves communications between an original sender and multiple recipients. Accordingly, a single message from the original sender can result in multiple responses to the message. In most cases, each recipient that responds to the original email message will include the original email message as a reference so that the recipients of the reply message do not need to “find” the original message. Since each response includes the original message several copies of the original message are stored within the email system of the original sender. This is extremely inefficient.

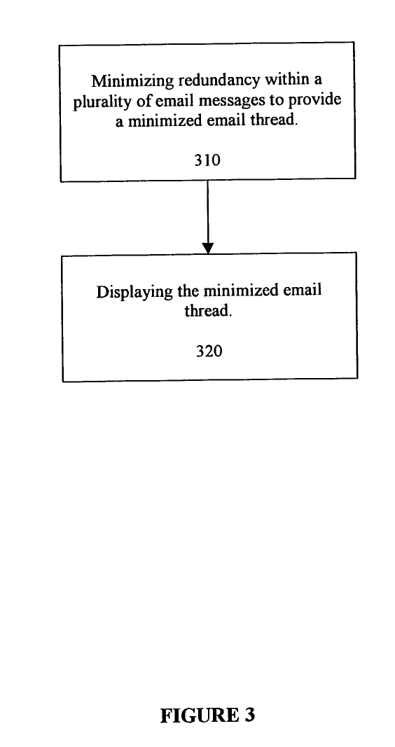

The present invention addresses this problem by minimizing the amount of redundancy within the email thread. To better understand the present invention, please refer to FIG. 3.

FIG. 3 is a high-level flow chart of the method of organizing an email thread in accordance with the present invention. First, a minimized email thread is provided by minimizing redundancy within a plurality of email messages, via step 310. Preferably, the plurality of email messages comprises an original message and at least one reply message. Next, the minimized email thread is displayed, via step 320. Preferably, the minimized email thread comprises the original message and at least one minimized reply message and the predetermined order comprises a chronological order wherein the chronological comprise an earliest to latest order or a latest to earliest order. Accordingly, the organized email thread is displayed in a more comprehensive fashion and stored as a single composite email document within the computer system. Additionally, by storing the email thread as a single composite email document, the entire thread can be forwarded and viewed by other recipients.

It should be noted that different email systems have different email display configurations. Accordingly, one of ordinary skill will readily recognize that the present invention can be configured to accommodate a variety of different email systems while remaining within the spirit and scope of the present invention.

In accordance with the present invention, a first client begins an email thread by sending an original message to multiple recipient clients at which time an associated email thread file is opened. The associated file is located somewhere within the first client system (e.g. the email program module 36, the local message store 38, etc.). When a first reply message, sent from one of the multiple recipients, is received by the first client, a comparison program within the first client's email system will compare the first reply message with the original message. The first reply message comprises a first portion of new content in addition to the original message and based on the comparison, the first client's email system will minimize the redundancy between the first reply message and the original message (e.g. truncate the original message from the first reply message) thereby creating a first minimized reply message. The first minimized reply message, which comprises the first portion of new content, is then combined with the original message and stored within the associated file. Both the first minimized reply message and the original message are then displayed.

Next, a second reply message is received by the first client. The second reply message is sent from within the group of multiple recipients sometime after the first reply message and comprises a second portion of new content in addition to the original message. This time, the comparison program within the first client's email system will compare the second reply message with the first minimized reply message and the original message and minimize the redundancy between the second reply message, the first reply message and the original message thereby creating a second minimized reply message. The second minimized reply message, which comprises the second portion of new content, is then combined with the first minimized reply message and original message and stored within the associated file. The second minimized reply message, the first minimized reply message and the original message are then displayed.

This process is continued as sequential reply messages are received by the first client system (e.g. a third minimized reply message is generated by comparing the third reply message with the second minimized reply message, the first minimized reply message and the original message; a fourth minimized reply message is generated by comparing the fourth reply message with the third minimized reply message, the second minimized reply message, the first minimized reply message and the original message; etc.). Accordingly, only the minimized reply messages, along with the original message, are displayed.

Although the above-described implementation is described as being utilized with multiple recipients, one of ordinary skill in the art will readily recognize that the present invention could also effectively be utilized with a single sender and a single recipient while remaining within the spirit and scope of the present invention. It should be noted that as the emails “volley” back and forth, the sender will become the recipient and the original recipient will become the sender. Also, another embodiment of the present invention could be user invoked by command to eliminate redundancy only within selected email documents. This embodiment could also include functionality that allows a user to select an email and issue a command for the system to find unselected email documents with components in common.

Ideally, the minimized reply messages are displayed, along with the original message, in a chronological order as they are received. The chronological order can either comprise an earliest to latest order (earlier reply messages are displayed first with the original message) or a latest to earliest order (later reply messages are displayed first with the original message). For example, in the case of the single email thread that comprises a succession of forwarded emails, the ordering of the minimized email thread could be chosen by the user to read chronologically forward or backward.

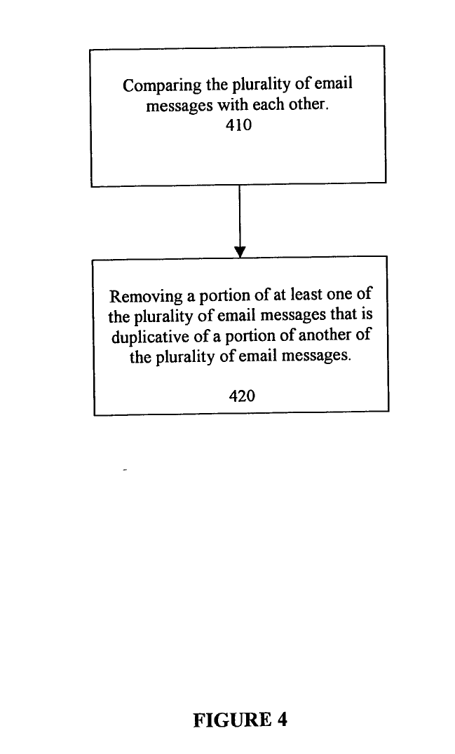

For a more detailed understanding of how the method in accordance with the present invention minimizes redundancy within the email thread, please refer to FIG. 4. FIG. 4 is a more detailed flowchart of step 310 of FIG. 3. First, the plurality of email messages are compared with each other, via step 410. Preferably, a comparison program is utilized to compare the plurality of email messages with each other. Next, a portion of at least one of the plurality of email messages is removed that is duplicative of a portion of another of the plurality of email messages, via step 420.

The comparison program implemented by the method in accordance with present invention can compare the text of the email message, the headers of the email messages, or any of a variety of parameters present within the email message in order to minimize the redundancy between email messages. Accordingly, one of ordinary skill in the art will readily recognize that a variety of implementations could be employed to compare the email messages while remaining within the spirit and scope of the present invention.

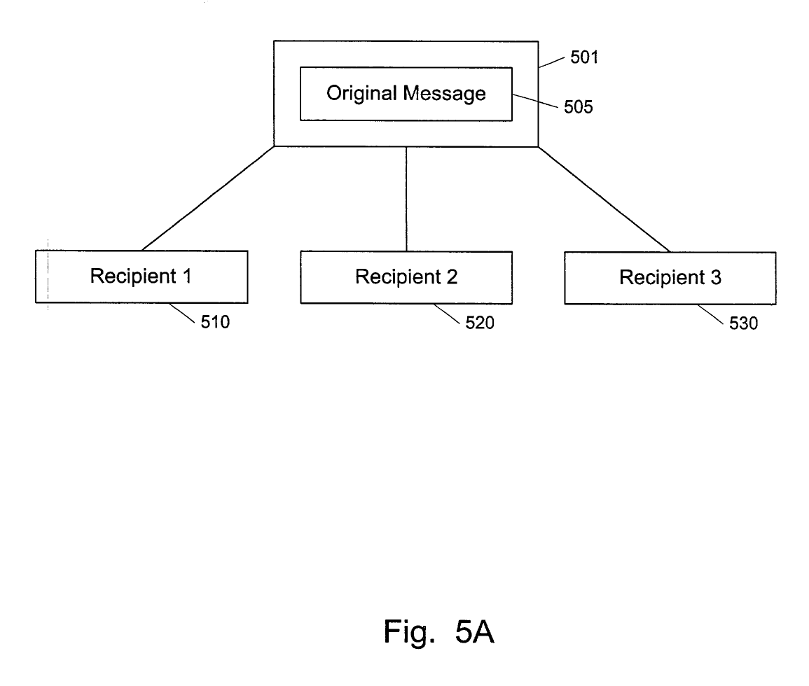

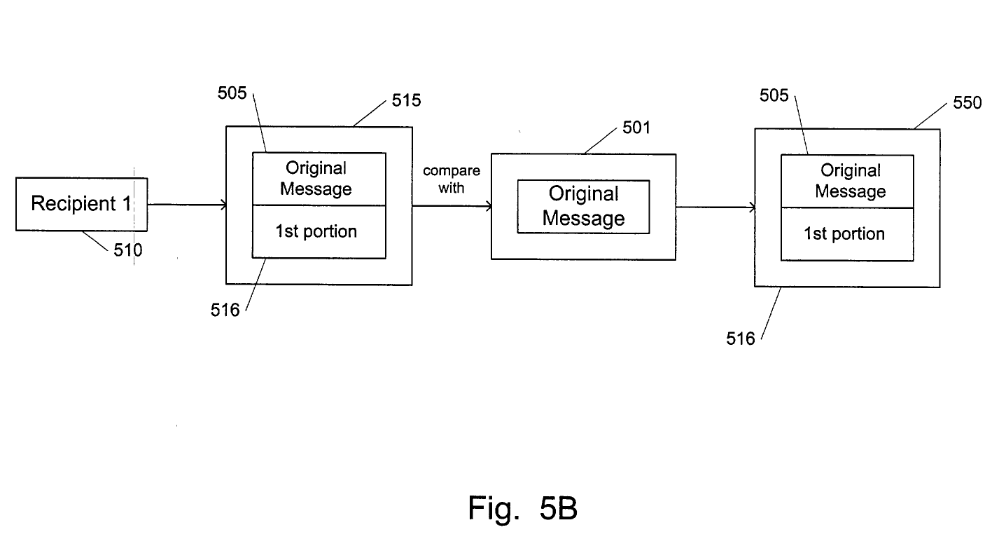

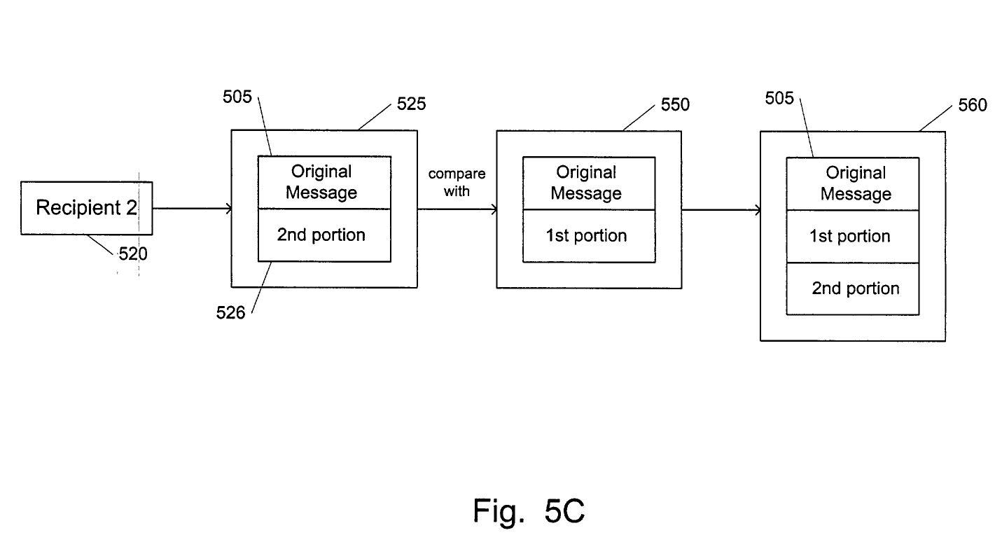

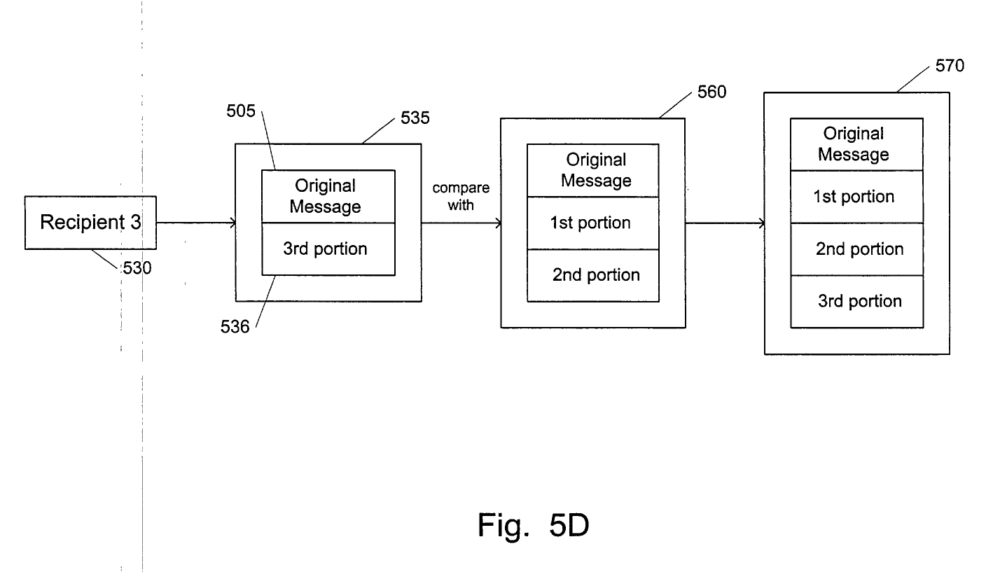

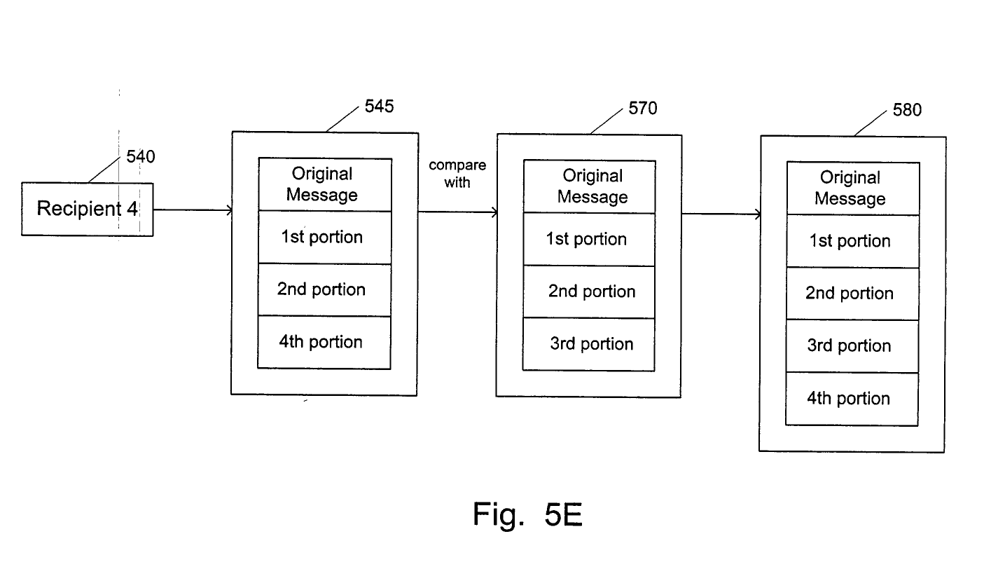

For a clearer understanding of the present invention please refer to FIGS. 5(A-D). FIGS. 5(A-D) represent diagrammed illustrations of the method in accordance with the present invention. FIG. 5(A) shows a diagram of a typical email conversation 500. This conversation 500 includes an original email 501 which comprises an original message from the sender (‘original message’) 505. This original message 505 is sent to, for example, a recipient group comprising three recipients 510, 520, 530.

Once the recipients receive the original message 505, they will accordingly respond to the message at which point the formation of the composite email will begin. Please refer now to FIGS. 5(B-D). FIGS. 5(B-D) diagram the formation of a composite email thread in accordance with the present invention.

Please refer now to FIG. 5(B). In response to the original email 501, the first recipient 510 sends a first reply message 515. This reply message 515 comprises the original message 505 and a first portion of new content 516. The first reply message 515 is then compared to the original email 501. At this point, a first minimized reply message 550 is created wherein the redundancy between the two messages is minimized (e.g. the original message i.e. the redundant portion, is truncated from the first reply message 515). As can be seen, the first minimized reply message 550 comprises the first portion of new content 516 and the original message 505. The first minimized reply message 550 is then stored in a file within the email system and displayed to the user.

Please refer now to FIG. 5(C). Next, the second recipient 520 sends a second reply message 525 in response to the original email 501. This reply message 525 comprises the original message 505 and a second portion of new content 526. The second reply message 525 is then compared to the first minimized reply message 550. A second minimized reply message 560 is then created wherein the redundancy between the two messages (the second reply message 525 and the first minimized reply message 550 is minimized. As can be seen, the second minimized reply message 560 comprises the first portion of new content 516, the second portion of new content 526 and the original message 505. The second minimized reply message 560 is then stored in the file and displayed to the user.

Please refer now to FIG. 5(D). Next, the third recipient 530 sends a third reply message 535 in response to the original email 501. The third reply message 535 comprises the original message 505 and a third portion of new content 536. The third reply message 535 is then compared to the second minimized reply message 560. A third minimized reply message 535 and the second minimized reply 560 are minimized. As can be seen, the third minimized reply message 570 comprises the original message 505, the first portion of new content 516, the second portion of new content 526, and the third portion of new content 536. The third minimized reply message 570 is then stored in the file and displayed to the user.

In another example, an e-mail is forwarded to a “new” recipient and then minimized. FIG. 5(E) is a block diagram of an example where a new recipient receives an e-mail from one of the participants. In this example, “new” recipient 540 receives an e-mail from recipient 520. As is seen initially, the e-mail message 545, which includes the original message, first portion, second portion and fourth portion, the fourth portion being provided by the recipient 520. The recipient 540 can then compare this e-mail to the minimized e-mail 570 from the recipient 530. In so doing, the third portion of the minimized e-mail 570 can be folded back into the minimized message 580 of the recipient 540. This allows a new recipient to fold back e-mails that have been missed.

A method and system for organizing an email thread is disclosed. Through the use of the method and system in accordance with the present invention, email threads are organized and displayed in a more comprehensive fashion. Furthermore, the amount of redundancy that occurs within an email thread is substantially reduced thereby minimizing the amount of computer memory/disk space that is consumed by the email system.

Although the present invention has been described in accordance with the embodiments shown, one of ordinary skill in the art will readily recognize that there could be variations to the embodiments and those variations would be within the spirit and scope of the present invention. Accordingly, many modifications may be made by one of ordinary skill in the art without departing from the spirit and scope of the appended claims.

What is claimed is:

1. A method for organizing an email thread in an email system, the email thread comprising a plurality of email messages, the plurality of email messages comprising an original message and at least one reply message, the method comprising the steps of:
a) minimizing redundancy within the plurality of email messages to provide a minimized email thread; and
b) displaying the minimized email thread.

2. The method of claim 1 wherein step a) further comprises:
a1) comparing the plurality of email messages with each other;
a2) removing a portion of at least one of the plurality of email messages that is duplicative of a portion of another of the plurality of email messages.

3. The method of claim 2 wherein step a1) comprises comparing a portion of the at least one of the plurality of email messages with a portion of the another of the plurality of email messages.

4. The method of claim 3 wherein step a1) further comprises comparing a header of the at least one of the plurality of email messages with a header of the another of the plurality of email messages.

5. The method of claim 1 wherein the at least one reply message is minimized and step b) further comprises:
b1) displaying the original message and the at least one minimized reply message in a predetermined order.

6. The method of claim 5 wherein the predetermined order comprises a chronological order and the chronological order comprises an earliest-to-latest order.

7. The method of claim 5 wherein the predetermined order comprises a chronological order and the chronological order comprises a latest-to-earliest order.

8. The method of claim 1 wherein step a) further comprises:
a1) selecting at least two of the plurality of email messages in the email system;
a2) comparing the at least two of the plurality of email messages with each other; and
a3) removing a portion of one of the at least two of the plurality of email messages that is duplicative of a portion of another of the at least two of the plurality of email messages.

9. A system for organizing an email thread, the email thread comprising a plurality of email messages, the plurality of email messages comprising an original message and at least one reply message, the system comprising:
means for minimizing redundancy within the plurality of email messages to provide a minimized email thread; and
means for displaying the minimized email thread.

10. The system of claim 9 wherein the means for minimizing redundancy further comprises:
means for comparing the plurality of email messages with each other;
means for removing a portion of at least one of the plurality of email messages that is duplicative of a portion of another of the plurality of email messages.

11. The system of claim 10 wherein the means for comparing comprises means for comparing a portion of the at least one of the plurality of email messages with a portion of the another of the plurality of email messages.

12. The system of claim 11 wherein the means for comparing further comprises means for comparing a header of the at least one of the plurality of email messages with header of another of the plurality of email messages.

13. The system of claim 9 further comprising means for minimizing the at least one reply message, and the means for displaying the minimized email thread further comprises:
means for displaying the original message and the at least one minimized reply message in a predetermined order.

14. The system of claim 13 wherein the predetermined order comprises a chronological order and the chronological order comprises an earliest-to-latest order.

15. The system of claim 13 wherein the predetermined order comprises a chronological order and the chronological order comprises a latest-to-earliest order.

16. The system of claim 9 wherein the means for minimizing redundancy within the plurality of email messages further comprises:
means for selecting at least two of the plurality of email messages;
means for comparing the at least two of the plurality of email messages with each other; and
means for removing a portion of one of the at least two of the plurality of email messages that is duplicative of a portion of another of the at least two of the plurality of email messages.

17. A computer readable medium containing program instructions for organizing an email thread, the plurality of email messages comprising an original message and at least one reply message, the program instructions comprising the steps of:
a) minimizing redundancy within the plurality of email messages to provide a minimized email thread; and
b) displaying the minimized email thread.

18. The computer readable medium of claim 17 wherein step a) further comprises:
a1) comparing the plurality of email messages with each other;
a2)removing a portion of at least one of the plurality of email messages that is duplicative of a portion of another of the plurality of email messages.

19. The computer readable medium of claim 18 wherein step a1) comprises comparing a portion of the at least one of the plurality of email messages with a portion of the another of the plurality of email messages.

20. The computer readable medium of claim 19 wherein step al) further comprises comparing a header of the at least one of the plurality of email messages with a header of the another of the plurality of email messages.

21. The computer readable medium of claim 17 wherein the at least one reply message is minimized and step b) further comprises:
b1) displaying the original message and the at least one minimized reply message in a predetermined order.

22. The computer readable medium of claim 21 wherein the predetermined order comprises a chronological order and the chronological order comprises an earliest-to-latest order.

23. The computer readable medium of claim 22 wherein the predetermined order comprises a chronological order and the chronological order comprises a latest- to-earliest order.

24. The computer readable medium of claim 17 wherein step a) further comprises:
a1) selecting at least two of the plurality of email messages;
a2) comparing the at least two of the plurality of email messages with each other; and
a3) removing a portion of one of the at least two of the plurality of email messages that is duplicative of a portion of another of the at least two of the plurality of email messages.

25. A method for organizing an email thread in an email system, the email system comprising a plurality of email messages, the method comprising the steps of:
a) selecting one of the plurality of email messages; and
b) finding another of the plurality of email messages wherein the another of the plurality of email messages comprises a portion thereof that is duplicative of a portion of the one of the plurality of email messages.

26. The method of claim 25 wherein step b) further comprises:
b1) comparing the one of the plurality of email messages with each of the plurality of email messages.
